(19) United States
(12) Patent Application Publication
(10) Pub. No.: US 2025/0289066 A1
(43) Pub. Date: Sep. 18, 2025

(54) GLAND REPAIR TOOLS, ASSEMBLIES, AND METHODS OF REPAIRING GLAND SEALS ON HIGH PRESSURE VALVES

(71) Applicant: Enerpac Tool Group Corp., Milwaukee, WI (US)

(72) Inventors: Bryan Hall, Newport (GB); Frank Havemann, Bedburg (DE)

(73) Assignee: Enerpac Tool Group Corp., Milwaukee, WI (US)

(21) Appl. No.: 19/075,951

(22) Filed: Mar. 11, 2025

Related U.S. Application Data
(60) Provisional application No. 63/566,488, filed on Mar. 18, 2024.

(51) Int. Cl. B23B 51/06; F16K 41/00

(52) U.S. Cl. CPC B23B 51/06; F16K 41/003

(57) ABSTRACT

A gland repair tool is for repairing a gland seal in a high-pressure valve. The gland repair tool includes a tool body configured for attachment to an injection shutoff device fitted to a wall of the valve that is opposite the gland seal. A drill passage extends through the tool body and is configured to receive a drill bit for drilling a hole through the wall. A rotary seal creates a seal preventing the high-pressure medium from escaping the drill passage past the drill bit. A cooling circuit includes a cooling fluid inlet configured to convey a cooling fluid into the drill passage, a cooling fluid outlet configured to convey the cooling fluid out of the drill passage, and a one-way valve configured to prevent the cooling fluid from escaping the drill passage via the cooling fluid inlet. Corresponding assemblies and methods of operating the gland repair tool are provided.

### CROSS REFERENCE TO RELATED APPLICATION

This application claims benefit of priority to U.S. Provisional Application No. 63/566,488, filed Mar. 18, 2024, which is hereby incorporated by reference in entirety.

### FIELD

The present disclosure relates to gland repair tools, assemblies, and methods of repairing gland seals on valves configured to control flow of a high-pressure medium.

### BACKGROUND

U.S. Pat. No. 5,062,439 is incorporated herein by reference and discloses a method and apparatus for injecting sealant into a packing assembly chamber surrounding a valve stem of a valve without venting the pressure within the valve. A cylindrical body is frictionally welded to the exterior of the valve adjacent the packing assembly chamber. A drill bit is passed into the body and through a set of packing seals. An opening is completed into the packing chamber. As the drill bit is withdrawn from the body, a second valve is manually closed to isolate the packing chamber from the drill bit and prevent the escape of pressurized fluid when the drill bit is removed from the seals. Thereafter, a device for injecting sealant is attached to the body and the valve is opened to allow the sealant to flow into the packing chamber.

### SUMMARY

This Summary is provided to introduce a selection of concepts which are further described below in the Detailed Description. This Summary is not intended to identify key or essential features of the claimed subject matter, nor is it intended to be used as an aid in limiting the scope of the claimed subject matter.

In non-limiting embodiments disclosed herein, a gland repair tool is for repairing a gland seal in a valve configured to control flow of a high-pressure medium. The gland repair tool comprises an elongated tool body having a rear end and a front end configured for attachment to an injection shutoff device fitted to a wall of the valve that is opposite the gland seal, a drill passage extending through the elongated tool body from the rear end to the front end, the drill passage being configured to receive a drill bit for drilling a hole through the wall, a rotary seal configured to create a seal that prevents the high-pressure medium from escaping the drill passage past the drill bit, and a cooling circuit including a cooling fluid inlet configured to convey a cooling fluid into the drill passage, a cooling fluid outlet configured to convey the cooling fluid out of the drill passage, and a one-way valve configured to prevent the cooling fluid from escaping the drill passage via the cooling fluid inlet.

In independent aspects, the gland repair tool further comprises a back stop in the drill passage, the back stop being configured to engage with an annular step on the drill bit to prevent ejection of the drill bit from the rear end of the elongated tool body under force of the high-pressure medium. The back stop may include a ledge that radially protrudes into the drill passage. The gland repair tool may further comprise the drill bit, wherein the drill bit is located in the drill passage and configured so that the annular step engages the back stop when the drill bit is placed under the force of the high-pressure medium. The back stop may include a ledge that radially protrudes into the drill passage and the annular step defines an increased diameter of the drill bit. The gland repair tool may further comprise a drill configured to rotate the drill bit to create the hole though the wall of the valve.

In independent aspects, the gland repair tool may further comprise a cap on the rear end of the elongated tool body, wherein the cap is configured to compress the rotary seal against the drill bit. In independent aspects, the gland repair tool may further comprise a forward stop for setting a drilling depth of the drill bit. In independent aspects, the cooling fluid inlet is coupled to the drill passage at a location that is axially offset from a location where the cooling fluid outlet is coupled to the drill passage to facilitate circulation of cooling fluid through an entire length of the drill passage between the rotary seal and the front end. In independent aspects, the gland repair tool is configured so that material/debris removed from the wall by the drill bit is transported away from the drill bit by the cooling fluid. In independent aspects, the gland repair tool is configured so that the cooling fluid in the drill passage resists ingress of the high-pressure medium into the drill passage.

In non-limiting embodiments disclosed herein, a gland repair tool assembly comprises the gland repair tool summarized herein above and further includes the injection shutoff device. In independent aspects, the gland repair tool assembly further comprises a drill configured to rotate the drill bit to drill the hole through the wall of the valve. In independent aspects, the injection shutoff device is configured to be clamped to wall of the valve. In independent aspects, the gland repair tool assembly further comprises a drill configured to rotate the drill bit.

In non-limiting embodiments disclosed herein, a method is for repairing a gland seal in a valve configured to control flow of a high-pressure medium. The method comprises fitting an injection shutoff device to the wall of the valve, attaching the gland repair tool described herein above to the injection shutoff device, flushing the drill passage with a cooling fluid via the cooling fluid inlet and the cooling fluid outlet, opening the injection shutoff device, operating the drill bit to drill through the wall of the valve to the gland seal while continuing to flush the drill passage with the cooling fluid, and closing the injection shutoff device.

In independent aspects, the method further comprises removing the gland repair tool from the injection shutoff device. In independent aspects, the method further comprises injecting a sealing compound into the valve via the injection shutoff device to repair the gland seal. In independent aspects the method further comprises closing the injection shutoff device after injecting sealing compound into the valve via the injection shutoff device. In independent aspects, the cooling fluid is water.

### BRIEF DESCRIPTION OF THE DRAWINGS

The present disclosure is described with reference to the following Figures. The same numbers are used throughout the Figures to reference like features and like components. Unless otherwise specifically noted, articles illustrated in the drawings are not necessarily drawn to scale.

FIG. 1 is a section view of a globe valve including a gland seal.

FIG. 2 is a detailed section view of the gland seal of the globe valve of FIG. 1.

FIG. 3 is a perspective view of an embodiment of a gland seal repair assembly.

FIG. 4 is an exploded perspective view of the gland repair tool, the drill bit, and the injection shutoff device of the gland seal repair assembly of FIG. 3

FIG. 5 is the detailed section view of FIG. 2, with a drill hole formed into a side wall of the globe valve.

FIG. 6 is a detailed perspective view depicting the attachment of the injection shutoff device to the wall of the globe valve of FIG. 5.

FIG. 7 is a detailed perspective view depicting attachment of the gland repair tool to the injection shutoff device of FIG. 5

FIG. 8 is a view of section 8-8, taken in FIG. 7, with the drill bit in a starting position.

FIG. 9 is a view of section 8-8, taken in FIG. 7, with the drill bit in an extended position drilling through the gland wall.

FIG. 10A is a view of section 8-8, taken in FIG. 7, with the drill bit in a retracted position after drilling through the valve wall to the gland seal.

FIG. 10B is a view of detail 10B, taken in FIG. 10A, depicting engagement between the drill bit and a backstop of the gland repair tool.

FIG. 11 is a view of section 8-8, taken in FIG. 7, with the injection shutoff device in the closed position and the gland repair tool disconnected from the injection shutoff device.

FIG. 12 is a perspective view of an injection shutoff device with a clamp mechanism.

FIGS. 13 and 14 are top schematic views of the injection shutoff device of FIG. 12 clamped onto valve bodies having different diameters.

### DETAILED DESCRIPTION OF THE DRAWINGS

As used herein, unless otherwise limited or defined, discussion of particular directions is provided by example only, with regard to particular embodiments or relevant illustrations. For example, discussion of “top,” “bottom,” “front,” “back,” “left,” “right,” “lateral,” “longitudinal,” or “vertical” features is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally, use of the words “first,” “second,” “third,” etc. is not intended to connote priority or importance, but merely to distinguish one of several similar elements from another.

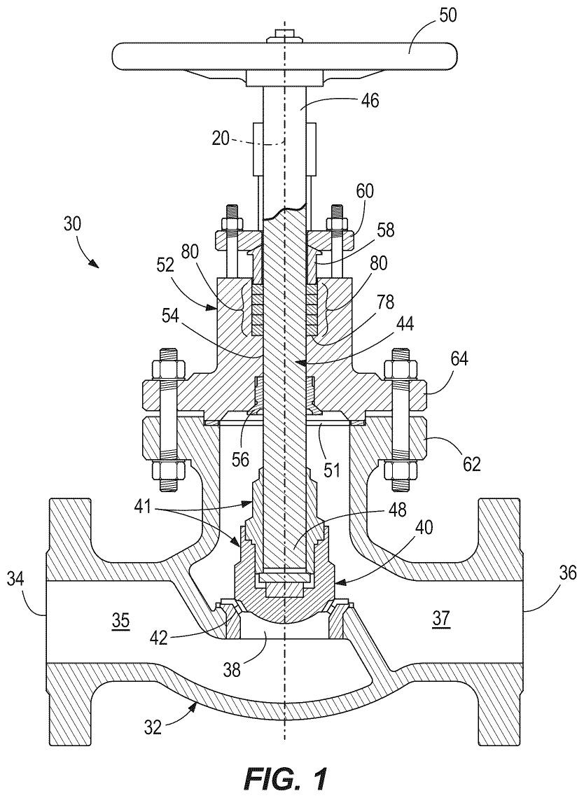

FIG. 1 illustrates an embodiment of a valve 30 which is configured to control the flow of a high-pressure medium through the valve 30 from a valve inlet 34 to a valve outlet 36. In the illustrated example, the valve 30 is configured as a globe valve. However, the type and configuration of the valve 30 is merely exemplary and may vary widely from what is shown. The illustrated globe valve 30 includes a valve body 32 that defines a valve flow path through the valve body 32 from the valve inlet 34 to the valve outlet 36 and a bonnet 52 coupled to the valve body 32. An inlet passage 35 (which forms part of the valve flow path) extends through the valve body 32 from the valve inlet 34 to a sealable opening 38. An outlet passage 37 (which also forms part of the valve flow path) is fluidically connected to the inlet passage 35 via the sealable opening 38 and extends from the sealable opening 38 to the valve outlet 36. The bonnet 52 is fastened to the valve body 32 and seals an access opening 51 through which the interior of the valve body 32 is accessible. In particular, the illustrated bonnet 52 includes a bonnet flange 64 that is coupled to a body flange 62 on the valve body 32 by mechanical fasteners. Some embodiments, however, may be differently configured.

To selectively allow the high-pressure medium to flow through the sealable opening 38, the globe valve 30 includes an actuator assembly 41 that extends through an axial bore 54 formed through the bonnet 52. The actuator assembly 41 includes a stem 44 that is movably received in the axial bore 54 such that the stem 44 is rotatable about a stem axis 20 defined by the axial bore 54. The stem 44 extends axially through the bore 54 from an exterior end 46 connected to a handle 50 on the exterior of the valve body 32 to an interior end 48 that supports a plug 40 positioned within the valve body 32 and in axial alignment with the sealable opening 38. The stem 44 is connected to the bonnet 52 and/or the valve body 32 such that rotation of the stem 44 about the stem axis 20 (for example, via manual rotation of the handle 50) causes the stem 44 and the plug 40 to move axially along the stem axis 20. Rotation of the handle 50 and stem 44 in a first direction causes the plug 40 on the interior end 48 of the stem 44 to move axially towards the sealable opening 38 and into a seated position (FIG. 1) in which the plug 40 is seated on seat member 42 formed around the sealable opening 38, thereby sealing the sealable opening 38 and preventing the flow of the high-pressure medium to flow through the globe valve 30. Rotation of the handle 50 and stem 44 in an opposite second direction causes the plug 40 on the interior end 48 of the stem 44 to move axially away from the sealable opening 38, thereby unseating the plug 40 from the seat member 42 and unsealing the opening 38 to permit the flow of high-pressure medium from the valve inlet 34 to the valve outlet 36. Thus, the globe valve 30 may be opened and closed by rotating the stem 44 in a first direction or a second direction to move the plug 40 into and between the seated position and the unseated position.

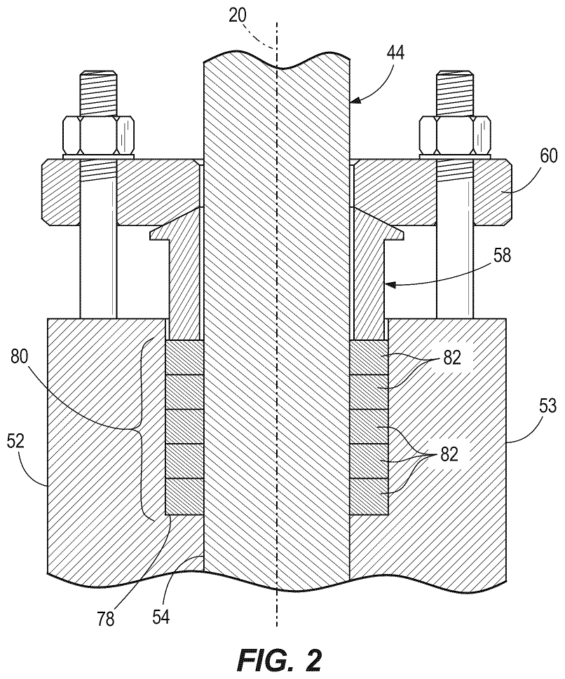

Referring to FIGS. 1 and 2, the globe valve 30 includes a gland seal 80 that is configured to form a seal between the radially outer surface of the stem 44 and the radially inner surface(s) of the axial bore 54 through the bonnet 52. The gland seal 80 is positioned in an annular gland chamber 78 formed around the stem 44 within the body of the bonnet 52. The gland seal 80 comprises at least one gland packing member 82 that extends annularly around the stem 44. In the illustrated embodiment, the gland seal 80 includes a packing cord with an elongated body that is wrapped around the stem 44. Some embodiments, however, may be configured with a gland seal formed from multiple gland packing members 82 stacked upon each other within the annular gland chamber 78. A gland follower 58 having a generally annular body is positioned on the stem 44 above the gland packing member(s) 82, and a gland bridge 60 clamps the gland follower 58 to the bonnet 52. The gland bridge 60 can be tightened onto the bonnet 52 to force the gland follower axially into the annular gland chamber 78. The gland packing member(s) 82 of the gland seal 80 are compressed between a lower surface of the annular gland chamber 78 and the gland follower 58, thereby compressing the gland packing member(s) 82 of the gland seal 80 to form a seal between the stem 44 and the bonnet 52.

During research and development, the present inventors determined that conventional valves designed for use with a high-pressure medium (e.g., the globe valve 30 of FIGS. 1-2) often experience wear during normal operation that degrades the gland seal, leading to leaks and eventually requiring replacement of the gland seal. The liquid and/or gas medium carried through these valves is typically maintained at high temperatures and/or pressure that may be hazardous, and in some cases, the medium may be toxic and/or flammable. As such, it can be important to repair the gland seal of a valve before a significant leak develops. The inventors found that current methods for the full replacement of a gland seal in a valve carrying high-pressure medium(s) require the shutdown of the fluid line process which the valve is part of, resulting in costly down time. Moreover, the inventors found that some ad-hoc gland seal repair methods used by repair technicians involve risky procedures that may put the health of the technician (and others in the area) at risk of exposure to hazardous conditions

Based on the above realizations, the present inventors determined there is a serious need in the art for a tool that enables a user to repair a valve gland seal while the valve is live (i.e., while the high-pressure medium is flowing through the valve), and which limits the risk of a user being exposed to any potentially hazardous substances carried through the valve. The present disclosure is a result of these efforts.

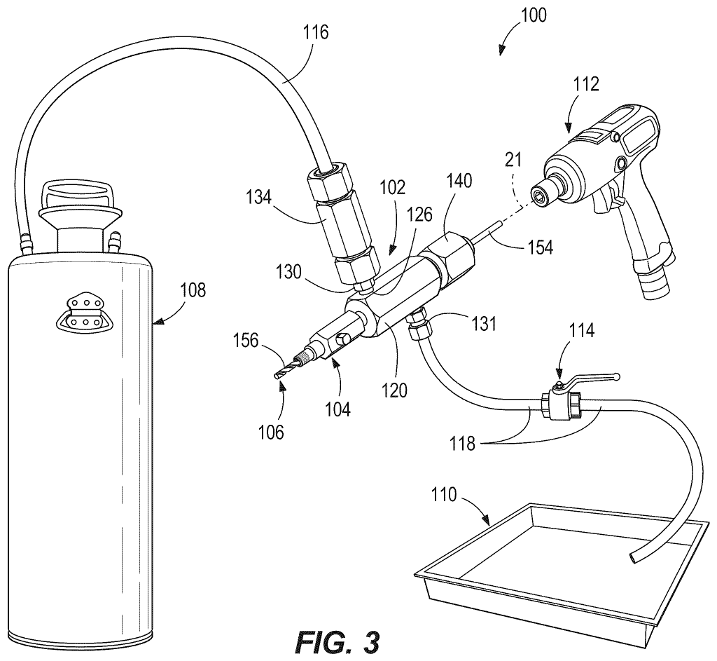

FIG. 3 illustrates an embodiment of a gland seal repair tool assembly 100 configured for repairing the gland seal 80 of a valve 30 through which a high-pressure medium is flowing without shutting the valve 30 (i.e., while the valve 30 is “live.”) Embodiments of the gland seal repair tool assembly 100 may include a gland repair tool 102, an injection shutoff device 104 for removably coupling the gland repair tool 102 to the valve 30, and a drill 112 configured to rotate a drill bit 106 extending through at least a portion of the gland repair tool 102. The gland repair tool 102 includes a cooling circuit that is configured to receive a cooling fluid from a cooling fluid supply 108, and to discharge the cooling fluid to a discharge reservoir 110.

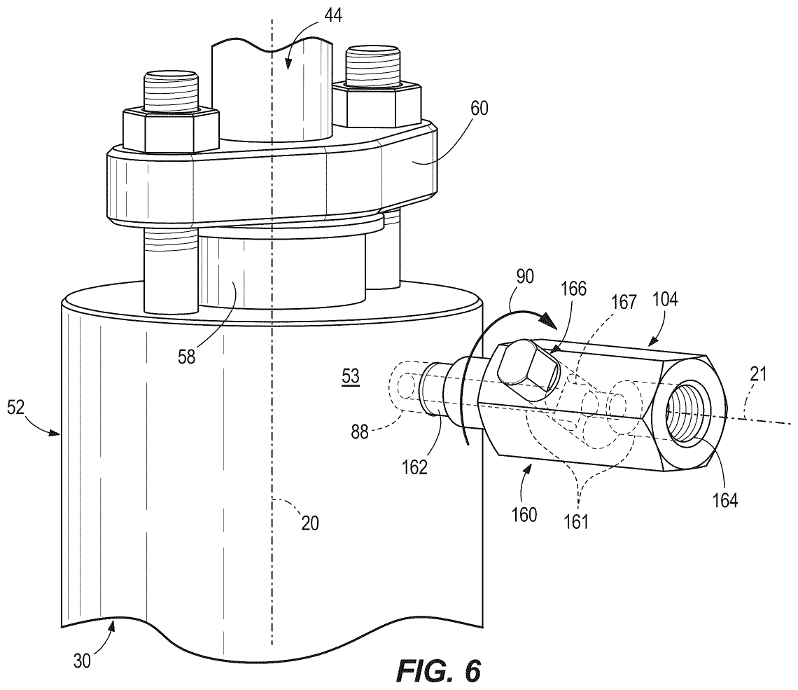

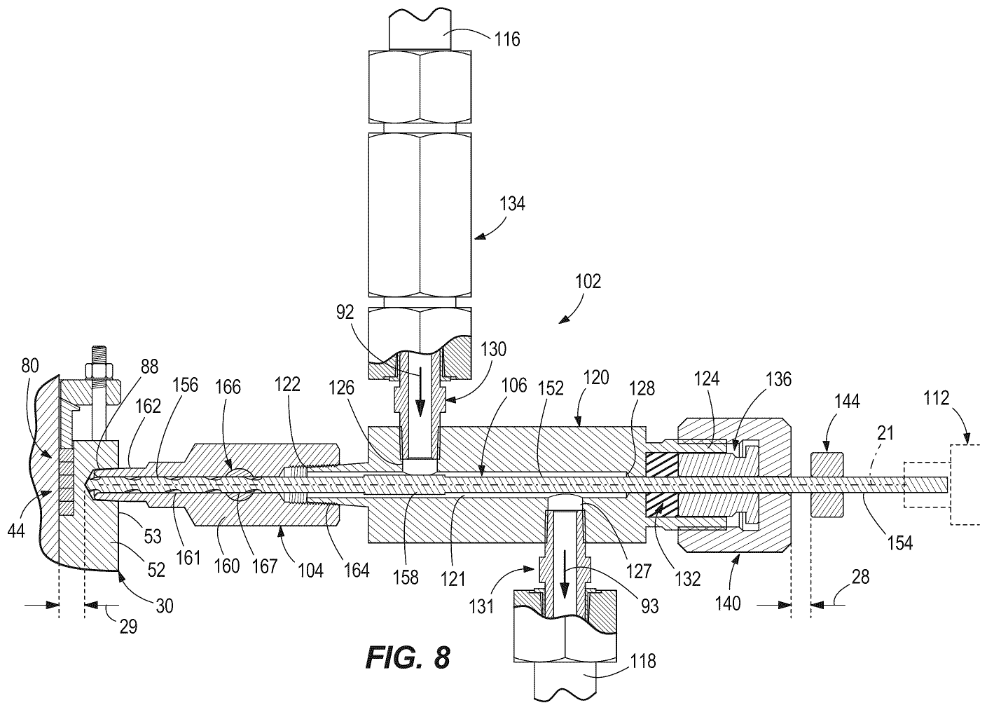

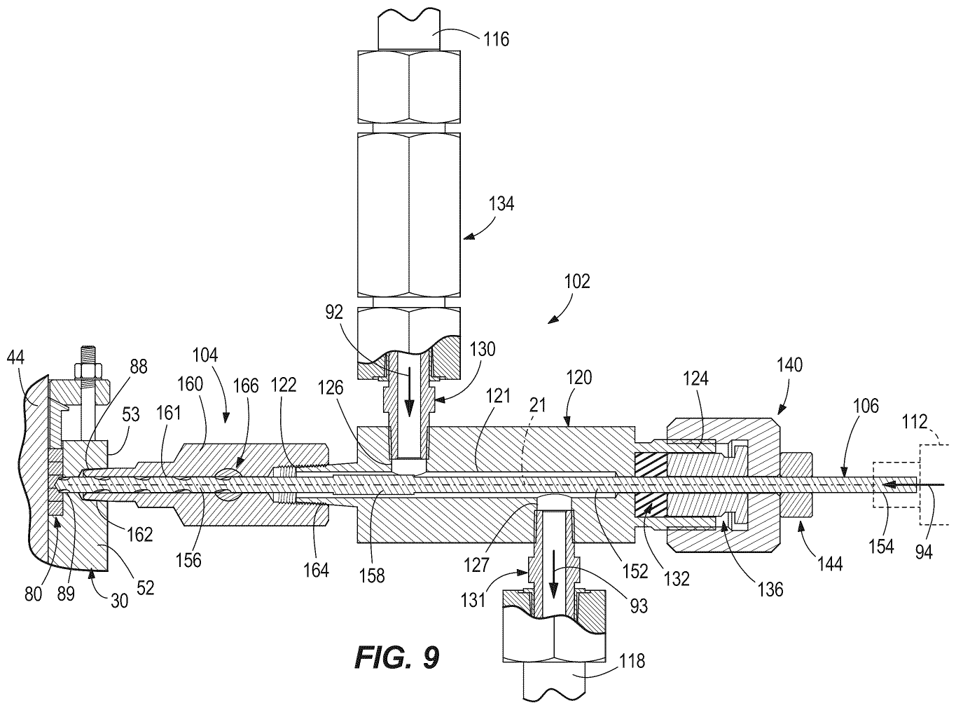

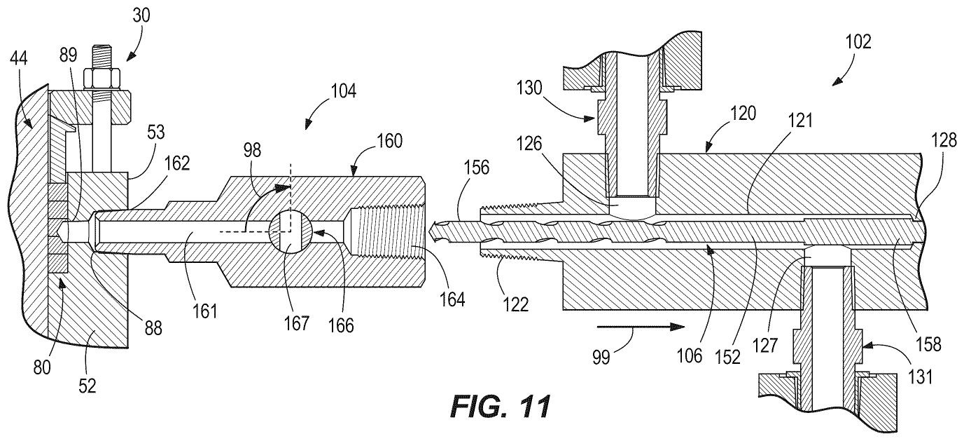

Referring to FIGS. 3, 4, and 6, the injection shutoff device 104 is configured to be removably fitted to a wall 53 of the valve 30 (FIG. 6). The injection shutoff device 104 has a body 160 that defines an axial passage 161 extending from a front end 162 to a rear end 164 of the injection shutoff device body 160. The front end 162 of the injection shutoff device 104 is configured to threadedly engage an initial bore 88 (see, e.g., FIG. 8) formed in the valve wall 53 to couple the injection shutoff device 104 to the bonnet 52 of the globe valve 30. In some embodiments, the injection shutoff device 104 may be removably coupled to the valve 30, while other embodiments may be configured with an injection shutoff device 104 that is permanently connected to the valve 30. The injection shutoff device 104 includes a gate member 166 that is rotatably received in a bore 168 formed in the side of the injection shutoff device body 160. The gate member 166 extends into the axial passage 161 and includes a gate passage 167 that is formed through the gate member 166 and allows the flow of fluids through the axial passage 161 in certain positions of the gate member 166. In a closed position of the injection shutoff device 104 (FIGS. 6 and 11), the gate member 166 is rotated so that the gate passage 167 is not aligned with the axial passage 161, thereby preventing the flow of fluid(s) through the axial passage 161. In an open position of the injection shutoff device 104 (FIGS. 8-10A), the gate member 166 is rotated so that the gate passage 167 is aligned with the axial passage 161, thereby allowing fluid(s) to flow through the axial passage 161, and to allow the drill bit 106 to be extended and retracted through the injection shutoff device 104.

Referring to FIGS. 3, 4, and 8, the gland repair tool 102 has an elongated body 120 with a front end 122, a rear end 124, and an internal drill passage 121 (FIG. 8) that extends axially through the elongated body from the front end 122 to the rear end 124. The front end 122 of the elongated body 120 is threaded and is configured to be attached to the injection shutoff device 104. In particular, the front end 122 of the elongated body 120 is configured to engage the rear end 164 of the injection shutoff device 104 to secure the gland repair tool 102 to the injection shutoff device 104. The drill passage 121 defines a drilling axis 21 and is configured to receive the drill bit 106 such that the drill bit 106 is axially slidable along the drilling axis 21 and rotatable about the drilling axis 21 while the drill bit 106 is positioned in the drill passage 121.

The drill bit 106 has an elongated drill shaft 152 that extends from a rear attachment end 154 configured to be connected to the drill 112 to a working end 156 configured to create a hole in a wall 53 of the valve 30 when the drill bit 106 is rotated by the drill 112. When the drill bit 106 is positioned in the drill passage 121, the attachment end 154 extends out from the rear end 124 of the elongated body 120 and the working end 156 may extend from the front end 122 of the elongated body 120. Between the attachment end 154 and the working end 156, the drill bit 106 includes an annular step 158, which defines an increased diameter of the drill bit 106 relative to the drill shaft 152. The annular step 158 is configured to prevent the drill bit 106 from being ejected from the gland repair tool 102 via the rear end 124 of the elongated body 120, as discussed in further detail below.

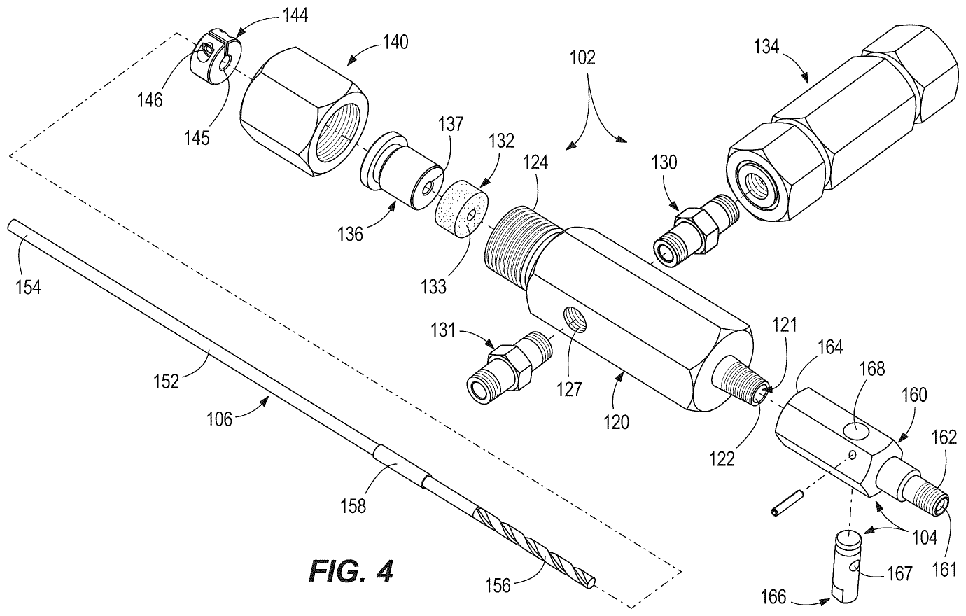

Referring to FIGS. 4 and 8, the gland repair tool 102 includes a rotary seal 132 positioned in the drill passage 121 proximate the rear end 124 of the elongated body 120. A center bore 133 of the rotary seal 132 is aligned with the drilling axis 21 such that the drill shaft 152 extends through the center bore 133. The rotary seal 132 is configured to form a seal between the drill bit 106 and the elongated body 120 that prevents the high-pressure medium and/or the cooling fluid from flowing past the drill bit 106 and escaping the drill passage 121.

In some embodiments, the gland repair tool 102 may include a clamp device/mechanism configured to compress the rotary seal 132 in the axial direction along the drilling axis 21 in order to form a seal between the drill shaft 152 and the elongated body 120. For example, the illustrated gland repair tool 102 includes a cap 136 and a clamping nut 140 at the rear end 124 of the elongated body 120. The cap 136 has a generally cylindrical body that is at least partially received in the rear end 124 and an axial center bore 137 that extends through the cylindrical body and is configured to receive the drill bit 106. The clamping nut 140 is configured to engage the rear end 124 of the elongated body 120 to retain the cap 136 and the rotary seal 132 in the rear end 124. The illustrated clamping nut 140 is configured to be threaded onto the rear end 124 and can be tightened on the elongated body 120 to press the cap 136 in the forward axial direction (i.e., towards the front end 122) to sandwich the cap 136 and the rotary seal 132 between the clamping nut 140 and the elongated body 120. Tightening the clamping nut 140 forces the cap 136 forward to squeeze and compress the rotary seal 132 between the cap 136 and the elongated body 120, thereby causing the rotary seal 132 to deform radially relative to the drilling axis 21, thereby compressing the rotary seal 132 against the radially outer surface of the drill bit 106 and a radially inner surface of the drill passage 121 to form a seal therebetween.

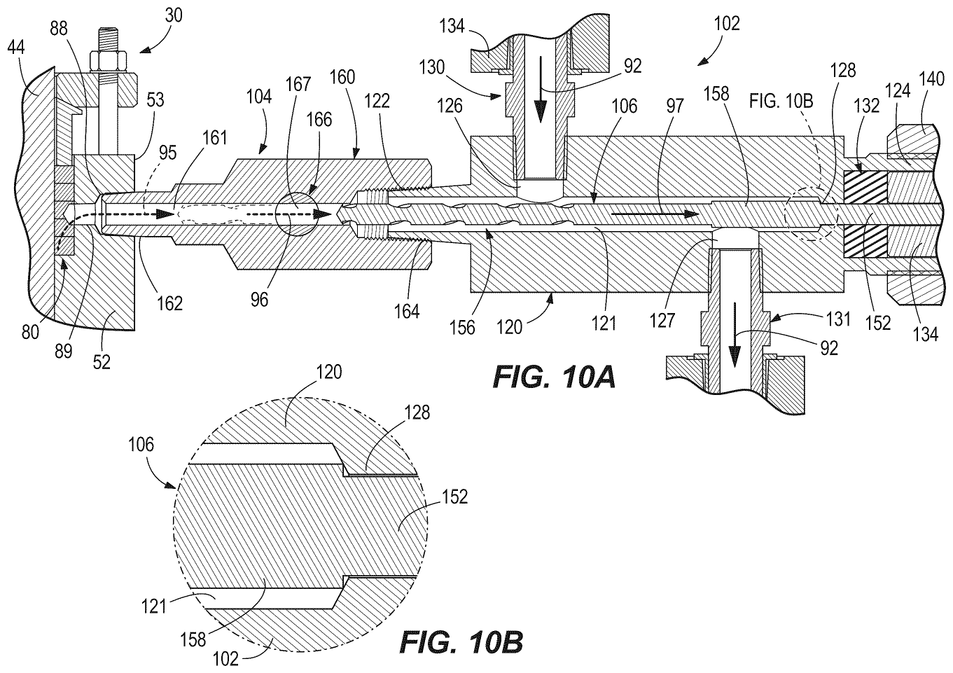

As previously mentioned, the drill bit 106 is slidable within the drill passage 121 along the drilling axis 21 to extend or retract the working end 156 of the drill bit 106 from the front end 122 of the elongated body 120. The illustrated gland repair tool 102 includes a back stop 128 (FIG. 10A, 10B) and a forward stop 144 (FIG. 4) which limit the axial movement of the drill bit 106 relative to the elongated body 120. Referring to FIGS. 10A and 10B, the gland repair tool 102 includes a back stop 128 in the drill passage 121 which is configured to prevent ejection of the drill bit 106 from the rear end 124 of the elongated tool body 120 under force of the high-pressure medium. In the illustrated embodiments, the back stop 128 includes a ledge that projects radially into the drill passage 121, thereby defining a reduced diameter of the drill passage 121. The back stop 128 is configured to engage the annular step 158 of the drill bit 106 to prevent the drill bit 106 from retracting past a fully retracted position (FIGS. 10A-11).

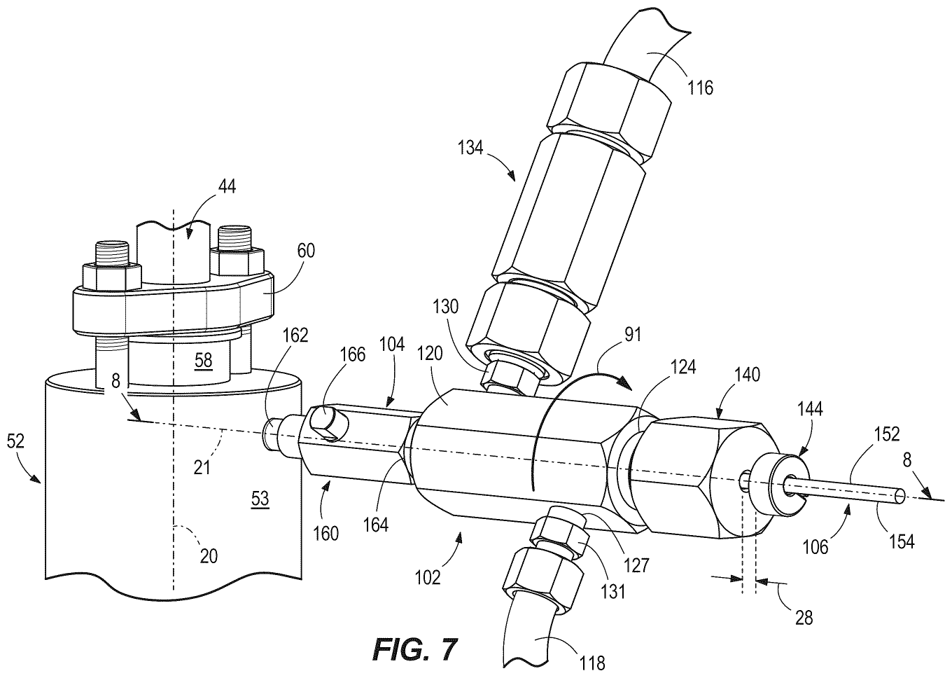

Referring to FIGS. 4 and 7, the gland repair tool 102 includes a forward stop 144 that can be adjusted along the drill shaft 152 in order to set a drilling depth for the drill bit 106. The forward stop 144 has a generally annular body with a center bore 145 configured to slidably receive the forward stop 144 onto the attachment end 154 of the drill bit 106. The forward stop 144 includes a tightening mechanism 146 that can selectively lock the forward stop 144 in an axial position relative to the drill shaft 152. By adjusting the location of the forward stop 144 on the drill bit 106 while the drill bit 106 is in the fully retracted position (FIG. 7), the axially movement of the drill bit 106 in a forward direction relative to the elongated body 120 can be limited by setting a fully extended position of the drill bit 106. In some embodiments, the position of the forward stop 144 on the drill bit 106 may be set based on a thickness of the wall 53 of the globe valve 30.

Referring to FIGS. 3 and 4, the illustrated gland repair tool 102 advantageously includes a cooling circuit with a cooling fluid inlet connector 130 and a cooling fluid outlet connector 131 that are configured to convey a cooling fluid into and out from the drill passage 121, respectively. The cooling fluid inlet connector 130 has a first end that is received in an inlet opening 126 that extends through a side wall of the elongated body 120 to the drill passage 121 and a second end that is configured to be connected to a cooling fluid supply 108 containing cooling fluid to be used as part of the gland seal repair method. In the illustrated embodiments, the cooling fluid inlet connector 130 is connected to the cooling fluid supply 108 via at least one conduit 116 and a one-way valve 134 located in the flow path between the cooling fluid inlet connector 130 and the cooling fluid supply 108.

The cooling fluid outlet connector 131 has a first end that is received in an outlet opening 127 that extends through a side wall of the elongated body 120 to the drill passage 121 and a second end that is configured to be connected to a discharge reservoir 110 for collecting cooling fluid that has been discharged from the gland repair tool 102 via the cooling fluid outlet connector 131. In the illustrated embodiments, the cooling fluid outlet connector 131 is connected to the discharge reservoir 110 via at least one conduit 118 and a discharge valve 114 configured to selectively allow fluid(s) to flow to the discharge reservoir 110 via the conduit(s) 118. The inlet opening 126 extends through the elongated body 120 at a first axial location proximate the front end 122 and the outlet opening 127 extends through the elongated body 120 at a second axial location located closer to the rear end 124 than the inlet opening 126. Thus, the cooling fluid inlet connector 130 is coupled to the drill passage 121 at a location that is axially offset from a location where the cooling fluid outlet connector 131 is coupled to the drill passage 121 to facilitate circulation of cooling fluid through an entire length of the drill passage 121 between the rotary seal 132 and the front end 122. Cooling fluid circulating in drill passage 121 and the axial passage 161 of the injection shutoff device 104 completely submerges the working end 156 of the drill bit 106 and the portion of the valve wall 53 which the drill bit 106 is acting on. This may be useful, for example, to prevent the formation of sparks and limit the risk of accidental combustion of any high-pressure medium that may be leaking from the valve 30.

Using an embodiment of the gland seal repair tool assembly 100, a user can repair the gland seal 80 on a globe valve 30 without requiring the shutdown of the fluid line in which the globe valve 30 is positioned. In the illustrated embodiments, the gland seal repair tool assembly 100 is depicted in use to repair the gland seal 80 of a globe valve 30. However, those skilled in the art will understand that methods for using the gland seal repair tool assembly 100 may be utilized to repair a gland seal on different valve types.

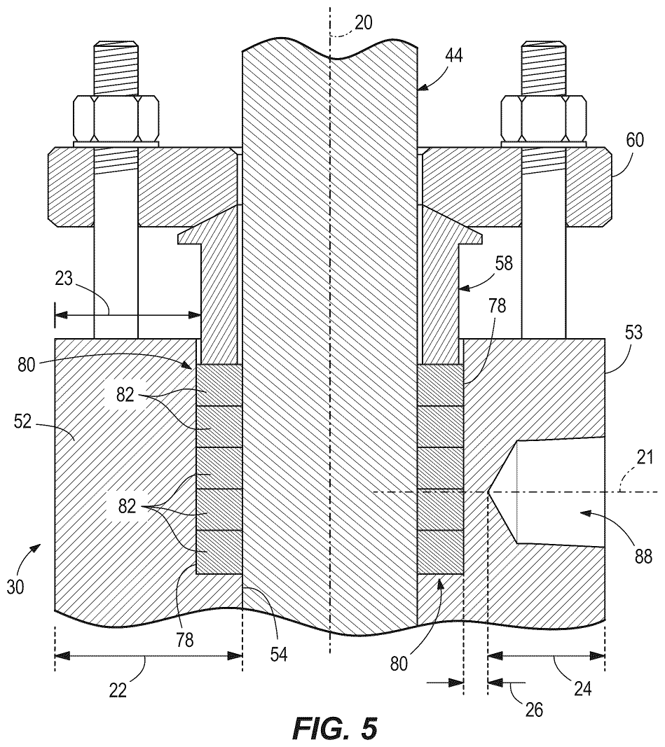

Referring to FIGS. 5 and 6, the injection shutoff device 104 is first connected to the wall 53 of the valve 30 by securing the front end 162 of the injection shutoff device 104 in a corresponding initial bore 88 formed into the wall 53. The initial bore 88 is formed with a diameter that corresponds to the diameter of the front end 162 of the injection shutoff device 104 and is formed about a drilling axis 21 that is aligned with a portion of the gland seal 80. A depth dimension 24 of the initial bore 88 may be based on a thickness 22 of the wall 53 between the exterior wall surface and the stem 44, a thickness 23 of the wall 53 between the exterior wall surface and the annular gland chamber 78/gland seal 80, and/or a desired remaining wall thickness 26 between the annular gland chamber 78/gland seal 80 and the deepest extent of the initial bore 88. In some embodiments, at least one of the wall thickness dimensions 23, 22 may be obtained using an ultrasonic device (not shown) to take ultrasonic thickness measurements. To facilitate connection of the injection shutoff device 104 to valve 30, the initial bore 88 may be formed with radially inner threads that are configured to engage exterior threads on the front end 162 of the injection shutoff device 104.

Once the initial bore 88 is formed in the wall 53 of the valve 30, the injection shutoff device 104 is fitted into the initial bore 88. For example, referring to FIG. 6, the front end 162 of the injection shutoff device 104 is threadedly engaged with the initial bore 88 by rotating the injection shutoff device 104 in a first direction indicated by arrow 90. When the injection shutoff device 104 is fitted to the wall 53 of the valve 30, the injection shutoff device 104 is axially aligned with the drilling axis 21 such that the axial passage 161 through the injection shutoff device 104 is coaxial with the drilling axis 21.

After fitting the injection shutoff device 104 to the wall of the valve 30, the elongated body 120 of the gland repair tool 102 may be attached to the injection shutoff device 104. For example, referring to FIG. 7, the front end 122 of the elongated body 120 (FIG. 4) is configured to be inserted into the rear end 164 of the injection shutoff device 104. The elongated body 120 of the gland repair tool 102 may be rotated in a first direction (e.g., as illustrated by arrow 91) to threadedly engage the front end 122 of the elongated body 120 with the rear end 164 of the injection shutoff device 104. When the elongated body 120 is connected to the injection shutoff device 104 mounted in the valve wall 53, the drill passage 121 through the elongated body 120 is axially aligned with the drilling axis 21, as illustrated in FIG. 8. Once the elongated body 120 is secured to the injection shutoff device 104, the cooling fluid inlet connector 130 is connected to the inlet opening 126 and the cooling fluid outlet connector 131 is connected to the outlet opening 127, thereby fluidically connecting the drill passage 121 to the cooling fluid supply 108 (via cooling fluid inlet connector 130, the one-way valve 134, and the cooling fluid supply conduit(s) 116) and the discharge reservoir 110 (via the cooling fluid outlet connector 131, the discharge valve 114, and the cooling fluid discharge conduit(s) 118. Additionally or alternatively, the cooling fluid inlet connector 130 and/or the cooling fluid outlet connector 131 may be connected to the corresponding inlet opening 126 or outlet opening 127 prior to attachment of the elongated body 120 to the injection shutoff device 104.

Referring to FIG. 8, after connecting the elongated body 120 to the injection shutoff device 104, the gate member 166 of the injection shutoff device 104 is moved into an open position (FIG. 8) in which the gate passage 167 is aligned with the drilling axis 21, thereby opening the injection shutoff device 104. With the gate member 166 in the open position, the drill bit 106 can be moved in a forward axial direction (i.e., towards the gland seal 80) along the drilling axis 21 to extend the working end 156 of the drill bit 106 through the injection shutoff device 104 and into contact with the remaining wall material between the initial bore 88 and the gland seal 80 in the annular gland chamber 78. The user may then adjust the axial position of the forward stop 144 along the shaft 152 of the drill bit 106 to set a maximum depth of the drill bit 106 in the wall 53 of the valve 30.

For example, with the working end 156 of the drill bit 106 abutting the deepest extent of the initial bore 88, a user may set the drilling depth for the drill bit 106 by adjusting a clearance 28 between the forward stop 144 and the clamping nut 140 on the rear end 124 of the elongated body 120. The clearance 28 between the forward stop 144 and the clamping nut 140 may be set based on the know or otherwise acquired dimensions of the valve 30 (e.g., the thickness 22 of the wall 53 between the exterior wall surface and the stem 44 and/or a thickness 23 of the wall 53 between the exterior wall surface and the gland seal 80). The axial clearance 28 between the forward stop 144 and the clamping nut 140 must be smaller than the axial distance 29 between the deepest extent of the initial bore 88 and the stem 44 in order to prevent the working end 156 of the drill bit 106 from being over extended and making contact with the stem 44.

After setting the drilling depth of the drill bit 106 by adjusting the forward stop 144, cooling fluid is supplied to the gland repair tool 102 via the supply conduit 116 in order to flush the drill passage 121 with cooling fluid from the cooling fluid supply 108 (FIG. 3). With continued reference to FIG. 8, cooling fluid is conveyed into the drill passage 121 through the one-way valve 134 and the cooling fluid inlet connector 130, for example along the flow path indicated by arrow 92. The cooling fluid flows into the elongated body 120 and is circulated through the entire length of the drill passage 121 (from the front end 122 to the rotary seal 132) and the axial passage 161 in the injection shutoff device 104. The cooling fluid circulating through the axial passages 121, 161 of the gland repair tool 102 and the injection shutoff device 104 is permitted to exit the gland repair tool 102 via the cooling fluid outlet connector 131 received in the outlet opening 127. Cooling fluid discharged via the outlet opening 127 is conveyed through at least one discharge conduit 118 and the opened discharge valve 114 (FIG. 3) and into the discharge reservoir 110. In some embodiments, cooling fluid may be conveyed to the drill passage 121 and circulated therein prior to opening the injection shutoff device 104 by rotating of the gate member 166. In the illustrated embodiments, the gland seal repair tool assembly 100 is configured to use water as a cooling fluid. Some embodiments, however, may be configured for use with a different cooling fluid. This disclosure is not limited for use with water and in fact is applicable for use with any other inert medium.

Once cooling fluid is circulating through the drill passage 121, the attachment end 154 of the drill bit 106 can be connected to a drill 112, and the user may operate the drill 112 to rotate the drill bit 106 and drill through the remaining portion of the wall 53 between the initial bore 88 and the gland seal 80. While the drill bit 106 is rotated by the drill 112, the drill bit 106 is pressed in a forward axial direction indicated by arrow 94, thereby driving the working end 156 into the wall 53 and forming a connecting bore 89 that extends between the gland seal 80 in the annular gland chamber 78. Advantageously, the circulation of the cooling fluid through the axial passages 121, 161 of the gland repair tool 102 and the injection shutoff device 104 transfers heat away from the drill bit 106, the wall 53, the injection shutoff device 104, and the gland repair tool 102 while the drill 112 is operated to drill through the wall 53.

As the drill bit 106 is driven by the drill 112 to drill through the wall 53, the working end 156 of the drill bit 106 removes material/debris from the wall 53 to form the connecting bore 89. The rotation of the drill bit 106 transports the material/debris removed from the wall 53 axially through the injection shutoff device 104 and into the drill passage 121. Advantageously, the material/debris introduced into the gland repair tool 102 during the drilling operation is transported away from the drill bit 106 by the circulating cooling fluid in the drill passage. The material/debris flows, with the cooling fluid, out of the gland repair tool 102 via the cooling fluid outlet connector 131 and into the discharge reservoir 110. Thus, unlike systems of the prior art which would require manual removal of the material/debris from the drill passage 121, the illustrated gland seal repair tool assembly 100 continuously circulates the cooling fluid through the drill passage 121 to remove impurities from the drill site, thereby preventing the impurities from entering the annular gland chamber 78. The user may continue to move the drill bit 106 axially forward while cooling fluid is circulated until it is in the fully extended position in which the forward stop 144 abuts the rear surface of the clamping nut 140, thereby completing the connecting bore 89 into the annular gland chamber 78 and providing access to the gland seal 80.

When the working end 156 of the drill bit 106 breaks through the wall 53 and enters into the annular gland chamber 78, the axial passages 121, 161 in the gland repair tool 102 and the injection shutoff devices 104 are fluidically connected to the annular gland chamber 78. Referring to FIG. 10A, the high-pressure medium is maintained at a higher pressure than that of the circulating cooling fluid in the drill passage 121 and therefore may be able to flow past the gland seal 80 and into the injection shutoff device 104 via the opening at the front end 162 thereof, for example along the flow path indicated by dashed arrow 95. As the high-pressure medium enters the injection shutoff device 104 and the gland repair tool 102, the resulting back pressure may force the drill bit 106 to slide axially rearward relative to the elongated body 120 and the injection shutoff device 104, for example in the direction of arrow 97. Advantageously, the one-way valve 134 prevents the back flow of any high-pressure medium back into the cooling fluid supply 108. In some embodiments, the pressure of the high-pressure medium may be sufficient to slide the drill bit 106 along the drilling axis 21 into a fully retracted position. Referring to FIG. 10B, the back stop 128 projecting into the drill passage 121 is engaged by the annular step 158 on the drill bit 106, thereby preventing further rearward axial movement of the drill bit 106. Advantageously, engagement between the back stop 128 and the annular step 158 prevents the drill bit 106 from being ejected from the elongated body 120 (with or without the drill 112 still attached thereto) at a potentially hazardous speed. In some embodiments, a user may need to manually retract the drill bit 106 into a retracted position in which the drill bit 106 no longer extends through the gate passage 167 in the gate member 166 of the injection shutoff device 104.

Referring back to FIG. 10A, after the bore 89 into the annular gland chamber 78 has been formed and the drill bit 106 has been retracted, the high-pressure medium may continue to flow through the axial passage 161 through the injection shutoff device 104, for example in the direction of dashed arrow 96. However, the ingress of the high-pressure medium into the gland seal repair tool assembly 100 is resisted by the cooling fluid circulating in the drill passage 121, which must be displaced before the high-pressure medium can enter the drill passage 121. In particular, the cooling fluid present in the drill passage 121 delays the flow of high-pressure medium into the gland repair tool 102, advantageously providing time for a user to close the injection shutoff device 104.

Referring to FIG. 11, a user can rotate the gate member 166, for example in the direction of arrow 98, to seal the axial passage 161 and prevent any additional high-pressure medium from leaving the valve 30 and entering the drill passage 121. Advantageously, any high-pressure medium that was able to enter the drill passage 121 is flushed out of the gland repair tool 102 and into the discharge reservoir 110 (FIG. 3), safely away from personnel and other risks. In some embodiments, the discharge reservoir 110 may be sealed or located remotely from the user, thereby limiting or preventing the user from being exposed to the potentially hazardous high-pressure medium. After closing the injection shutoff device 104, the gland repair tool 102 can be disconnected from the injection shutoff device 104 and retracted out from the rear end 164 thereof, for example in the direction of arrow 99. Sealing of the shut-off gate 166 may be verified by closing the discharge valve 114, ceasing flow of the cooling fluid to the gland repair tool 102, and then opening the discharge valve 114 again to see if there is a burst of pressure into the discharge reservoir 110. A burst of pressure indicates that the seal at the shut-off gate 166 is not complete, and thus further attention is required before removing the glans repair tool 102. For example it may be possible for debris or material to be trapped in the shutoff-gate 166 which would prevent it from fully closing. At this point it may be necessary to repeat the above-described drilling operation.

Following the removal of the elongated body 120 of the gland repair tool 102 from the injection shutoff device 104, a user may inject a sealing compound (not shown) into the annular gland chamber 78 of the valve 30 via the injection shutoff device 104 to repair the gland seal 80.

For example, in some embodiments, a sealing compound injector device (not shown) may be connected to the injection shutoff device 104 via the rear end 164 thereof. After opening the injection shutoff device 104, the sealing compound injector device can be operated to inject the sealing compound into the annular gland chamber 78 via the axial passage 161, the initial bore 88, and the connecting bore 89. The injected sealing compound fills the annular gland chamber 78 and supplements the sealing performance of the remaining gland packing member(s) 82 in the annular gland chamber 78, thereby repairing the gland seal 80.

After the sealing compound has been injected into the annular gland chamber 78 to repair the gland seal 80, the gate member 166 is rotated to close the injection shutoff device 104 and the sealing compound injector device is removed therefrom. To verify that the injection shutoff device 104 is fully closed, the user may close the discharge valve 114 located in-line with the discharge conduit(s) 118 for a short period of time (e.g., 30 seconds) before reopening the discharge valve 114. If no pressure is released from the gland repair tool 102 upon reopening the discharge valve 114, then the injection shutoff device 104 is fully closed. In some embodiments, the injection shutoff device 104 is configured to be permanently installed on the valve 30 to retain the sealing compound in the annular gland chamber 78, and/or to facilitate future repairs of the gland seal 80.

Thus, it will be understood by those having ordinary skill in the art that the gland repair tools 102, gland seal repair tool assemblies 100, and methods for repairing a gland seal of the present disclosure advantageously enable a user to repair the gland seal 80 of a valve 30 while high-pressure medium is flowing through the valve 30, thereby avoiding costly shutdowns of the fluid process line. Using the gland repair tool assembly 102, a user is able to safely repair a gland seal 80 without risking exposure to fluids and/or gasses that have hazardous temperature and/or pressure levels. The continuous circulation of cooling fluid through the gland repair tool 102 during the drilling operation cools the drill bit 106 and the drilling surface (i.e., the gland wall 53) while also flushing away any debris created as the drill bore is formed. The circulating cooling fluid also completely submerges the working end 156 of the drill bit 106 and the drilling surface, thereby preventing the formation of sparks and reducing the risk of a combustible substance from igniting. Advantageously, the gland seal repair tool assembly 100 discharges the cooling fluid, any debris/material carried in the cooling fluid, and any high pressure medium that has leaked into the gland repair tool 102 to a remote discharge reservoir 110, thereby reducing the user's risk of exposure to hazardous materials.

Some embodiments of a gland seal repair tool assembly may be configured with an injection shutoff device that is secured to the wall of a valve via a clamping arrangement. This may be useful, for example, to fit an injection shutoff device to a valve with a relatively thin wall that is insufficient for threadedly coupling the injection shutoff device thereto.

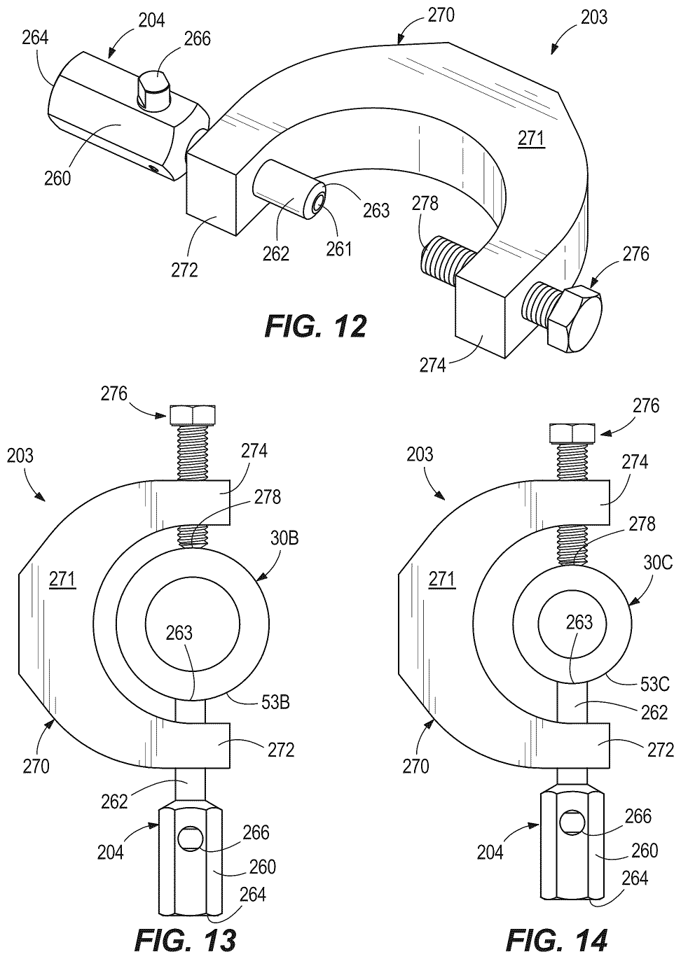

For example, FIG. 12 illustrates an embodiment of a clamping injection shutoff device 203 that includes an injection valve assembly 204 and a clamp 270 configured to couple the injection valve assembly 204 to the wall 53 of a valve 30. The clamp 270 includes a generally C-shaped clamp frame 271 that extends between opposing first and second ends 272, 274. The injection valve assembly 204 has a body 260 with a gate member 266 operable to open and close the clamping injection shutoff device 203 and a stem portion 262 that extends from the body 260, through the first end 272 of the clamp frame 271, to a front end 263 of the stem. The injection valve assembly 204 defines an axial passage 261 extending through the body 260 and the stem 262 from a rear end 264 of the body 260 to the front end 263 of the stem 262. A clamp member 276 extends through the second end 274 of the clamp frame 271 such that the clamp member 276 is aligned with the axial passage 261 through the injection valve assembly 204.

Referring to FIGS. 12-14, the clamp member 276 is adjustable relative to the clamp frame 271 in order to clamp the injection shutoff device 203 to the wall 53B, 53C of valve bodies 30B, 30C of various different sizes. The illustrated clamping member 276 is threadedly engaged with the clamp frame 271 such that rotation of the clamping member 276 in a first direction advances a distal end 278 of the clamping member 276 towards the stem 262 of the injection valve assembly 204 on the opposite end 272 of the clamp frame 271. Rotation of the clamping member 276 in an opposite second direction retracts the distal end 278 of the clamping member 276 away from the stem 262 of the injection valve assembly 204.

To secure the clamping injection shutoff device 203 to the wall 53B, 53C of a valve 30B, 30C, the clamp fame 271 is moved into a position in which the valve 30B, 30C is between the first end 272 and the second end 274 of the clamp frame 217. The clamping member 276 may then be rotated to decrease the clearance between the front end 263 of the stem 262 and the distal end 278 of the clamping member 276 until the diametrically opposite sides of the wall 53B, 53C of a valve 30B, 30C are engaged by the stem 262 and the clamping member 276, thereby securing the clamping injection shutoff device 203 to the valve 30B, 30C.

Although specific advantages have been enumerated above, various examples may include some, none, or all of the enumerated advantages. Other technical advantages may become readily apparent to one of ordinary skill in the art after review of the present specification. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order.

In the present description, certain terms have been used for brevity, clarity, and understanding. No unnecessary limitations are to be implied therefrom beyond the requirement of the prior art because such terms are used for descriptive purposes only and are intended to be broadly construed. The different apparatuses described herein may be used alone or in combination with other apparatuses. Various equivalents, alternatives and modifications are possible within the scope of the appended claims.

What is claimed is:

1. A gland repair tool for repairing a gland seal in a valve configured to control flow of a high-pressure medium, the gland repair tool comprising:
an elongated tool body having a rear end and a front end configured for attachment to an injection shutoff device fitted to a wall of the valve that is opposite the gland seal,
a drill passage extending through the elongated tool body from the rear end to the front end, the drill passage being configured to receive a drill bit for drilling a hole through the wall,
a rotary seal configured to create a seal that prevents the high-pressure medium from escaping the drill passage past the drill bit, and
a cooling circuit including a cooling fluid inlet configured to convey a cooling fluid into the drill passage, a cooling fluid outlet configured to convey the cooling fluid out of the drill passage, and a one-way valve configured to prevent the cooling fluid from escaping the drill passage via the cooling fluid inlet.

2. The gland repair tool according to claim 1, further comprising a back stop in the drill passage, the back stop being configured to engage with an annular step on the drill bit to prevent ejection of the drill bit from the rear end of the elongated tool body under force of the high-pressure medium.

3. The gland repair tool according to claim 2, wherein the back stop includes a ledge that radially protrudes into the drill passage.

4. The gland repair tool according to claim 2, further comprising the drill bit, wherein the drill bit is located in the drill passage and configured so that the annular step engages the back stop when the drill bit is placed under the force of the high-pressure medium.

5. The gland repair tool according to claim 4, wherein the back stop includes a ledge that radially protrudes into the drill passage and the annular step defines an increased diameter of the drill bit.

6. The gland repair tool according to claim 4, further comprising a drill configured to rotate the drill bit to create the hole though the wall of the valve.

7. The gland repair tool according to claim 1, further comprising a cap on the rear end of the elongated tool body, wherein the cap is configured to compress the rotary seal against the drill bit.

8. The gland repair tool according to claim 1, further comprising a forward stop for setting a drilling depth of the drill bit.

9. The gland repair tool according to claim 1, wherein the cooling fluid inlet is coupled to the drill passage at a location that is axially offset from a location where the cooling fluid outlet is coupled to the drill passage to facilitate circulation of cooling fluid through an entire length of the drill passage between the rotary seal and the front end.

10. The gland repair tool according to claim 1, configured so that material/debris removed from the wall by the drill bit is transported away from the drill bit by the cooling fluid.

11. The gland repair tool according to claim 1, configured so that the cooling fluid in the drill passage resists ingress of the high-pressure medium into the drill passage.

12. A gland repair tool assembly comprising the gland repair tool according to claim 1 and further including the injection shutoff device.

13. The gland repair tool assembly according to claim 12, further comprising a drill configured to rotate the drill bit to drill the hole through the wall of the valve.

14. The gland repair tool assembly according to claim 12, wherein the injection shutoff device is configured to be clamped to wall of the valve.

15. The gland repair tool assembly according to claim 12, further comprising a drill configured to rotate the drill bit.

16. A method of repairing a gland seal in a valve configured to control flow of a high-pressure medium, the method comprising:
fitting an injection shutoff device to the wall of the valve,
attaching the gland repair tool according to claim 1 to the injection shutoff device,
flushing the drill passage with a cooling fluid via the cooling fluid inlet and the cooling fluid outlet,
opening the injection shutoff device,
operating the drill bit to drill through the wall of the valve to the gland seal while continuing to flush the drill passage with the cooling fluid, and
closing the injection shutoff device.

17. The method according to claim 16, further comprising removing the gland repair tool from the injection shutoff device.

18. The method according to claim 17, further comprising injecting a sealing compound into the valve via the injection shutoff device to repair the gland seal.

19. The method according to claim 18, further comprising closing the injection shutoff device after injecting sealing compound into the valve via the injection shutoff device.

20. The method according to claim 16, wherein the cooling fluid is water.
